(19) United States
(12) Patent Application Publication
(10) Pub. No.: US 2015/0246792 A1
(43) Pub. Date: Sep. 3, 2015

(54) ELEVATOR CAR WITH A MAINTENANCE WINDOW

(71) Applicant: Inventio AG, Hergiswil (CH)

(72) Inventor: Daniel Baltis, Kriens (CH)

(21) Appl. No.: 14/417,306

(22) PCT Filed: Jul. 11, 2013
(86) PCT No.: PCT/EP2013/064704

§ 371 Date: Jan. 26, 2015

(30) Foreign Application Priority Data
Jul. 27, 2012 (EP) 12178188.4

(51) Int. Cl. B66B 11/02; B66B 5/00

(52) U.S. Cl. CPC B66B 11/0246; B66B 5/005; B66B 5/0087

(57) ABSTRACT

An elevator car has a lateral maintenance window and a panel which in a normal position covers an opening in the maintenance window such that the panel can be opened. When the panel is opened, a spacer bracket in the maintenance window can be brought into a maintenance position so that a barrier is provided at a safe distance from passing elevator components. A safety device is also provided which monitors whether the panel is in the normal position and whether the spacer bracket is located in the maintenance position. The safety device blocks normal travel as well as inspection travel of the elevator car when the panel is not located in the normal position and the spacer bracket is not located in the maintenance position. Inspection travel can only be enabled by the safety device if the spacer bracket is located in the standby position.

### FIELD

The invention relates to an elevator car with a side maintenance window.

### BACKGROUND

Elevators must be regularly checked and maintained to ensure adequate security. Elevator components such as guides for counterweights, guides of the elevator car, chassis, suspension ropes, etc. must be checked, which extend in the elevator shaft often at least partially along the side of the elevator car. In particular, an elevator drive can be arranged to the side of the elevator car in the elevator shaft.

For this purpose it is known to provide a maintenance window in a side wall of the elevator car. An elevator mechanic can use the maintenance window to check, from the car interior, the components placed at the relevant side in the elevator shaft and, if need be, maintain them. An appropriate maintenance window is known for example from WO 01/79104 A1. In this case, the elevator mechanic initially moves the elevator car to a desired location and then opens the maintenance window to perform the required maintenance.

However, it is often advantageous if a travel is possible with the maintenance window being open, to be able to position the elevator car as desired. Such inspection travels are typically carried out with a speed reduced relative to a normal travel. However, such an inspection travel poses comparatively high risks for the elevator mechanic. Elevator components are often in great proximity to the maintenance window (relative to the elevator car), so that e.g. clothes of the elevator mechanic can be caught. It is therefore necessary to ensure appropriate safety distances of the elevator mechanic to the elevator components. In addition, it must be ensured that no normal travel is possible with the maintenance window open. For this purpose, the relevant regulations must be observed.

WO 2008/074 167 A1 discloses an elevator car with a maintenance window, in which a barrier is intended to ensure that the required safety distances are complied with. The maintenance window is closed by a removable panel. After its removal, the panel is put by the elevator mechanic on the car floor leaning as a safety barrier against the car wall, in which the maintenance window is formed. In this case, a spacer such as a handrail is provided, which determines a distance of the panel from the car wall. After stopping, a cable of a car safety device is connected to the panel, which releases an inspection drive. With the panel being removed and no connection of the safety device, no car travel is possible. These devices make sure that the car is not mobile as long as the maintenance window is open and no security barrier is set up. However, the arrangement of the barrier and the connection of the safety device are complex for the elevator mechanic and therefore less comfortable to use. In addition, the safety device does not ensure that the barrier is properly positioned and forms a security barrier. For example, the barrier could fall over during the travel, if e.g. it is not properly mounted on the handrail. Since the position on the panel can only be verified via the connection of the cable, the panel can, for example, be leaning obliquely so that on one side the safety distance is smaller. The elevator mechanic is therefore unnecessarily exposed to risks, because under certain circumstances an inspection travel is feasible with the safety device connected, but the barrier is not correctly arranged.

### SUMMARY

It is therefore the task of the invention to overcome the disadvantages of the prior art, In particular, it is a task of the invention to provide an elevator car with a lateral maintenance window, which ensures optimum safety and ease of use.

This task is resolved by an elevator car with a side maintenance window, and a panel, which in a normal position evidently covers an opening of the maintenance window. Especially with an open maintenance window, a spacer can be brought in a maintenance position at the maintenance window in such a manner that a barrier is provided at a safe distance from the passing elevator components. A safety device monitors whether the panel is in the normal position, and whether the spacer is in the maintenance position. The invention is characterized in that the safety device blocks a normal travel as well as an inspection travel of the elevator car if the panel is not in the normal position and the spacer is not in the maintenance position. An inspection travel can be released by the safety device only when the spacer is in the maintenance position.

Preferably, the inspection travel is released automatically when the spacer is in the maintenance position. In this case, no further manipulations, such as flipping the lock switch that is released only in the maintenance position, by the elevator mechanic are required.

The inventive solution has the advantage that an inspection travel is only released when the spacer is actually located in a maintenance position, in which a barrier with a safe distance is set up. When placed in the maintenance position, the spacer may, for example, be automatically locked. Similarly, the spacer can be locked manually, e.g. by tightening a screw or inserting a splint. But a sufficient security is guaranteed even without locking according to the invention, because the inspection travel would immediately be interrupted if the spacer differs from a maintenance position. It is understood that, in principle, several maintenance positions or a range of maintenance positions may be provided, in which a barrier is ensured with a sufficient safety distance.

The spacer may be formed, for example, as a separate plate element or bracket member, which in the maintenance position can, for example, be inserted from the car interior into the corresponding brackets of the elevator car. For this purpose, the spacer may be stowed, for example, in the elevator car. Similarly, the spacers can be mounted on the elevator car and be swung into the maintenance position, for example, inside the car interior. It is understood that the safety distance and the height of the barrier above the car floor provided by the spacer is largely free and can be selected according to the requirements or the rules.

Preferably, the safety device comprises a first safety contact, which can be activated by bringing the panel into the normal position. The safety contact can be formed for example as a switch or a button, but can also be activated magnetically or otherwise. Preferably, the safety contact is designed as simple and robust as possible. Advantageously, the first security contact is activated directly by the panel when it gets into the normal position or is placed in it. Basically, a simple electrical contact switch is conceivable, which is closed at the insertion of the panel into the maintenance window. With advantage a locking device is also provided, through which the panel can be locked in the normal position, such as a closing device with a lock. In this case, the first safety contact can be activated by the locking device and only when the panel is locked in the normal position. To open the maintenance window, the panel may be formed, for example, as a single or multi-piece swing-wing. Preferably, however, the panel is designed for opening removable so that an opening of the open maintenance window is fully released.

Advantageously, the safety device comprises a second safety contact, which can be activated by placing the spacer in the maintenance position. The second security contact can be formed largely similar to the first safety device. The second safety contact can preferably be activated directly by the spacer when it has reached the maintenance position or is arranged therein.

It is understood that instead of a safety contact, other monitoring devices can be provided both for the panel and the spacer. For example, it could also be detected by means of optical or acoustic sensors, if the panel is in the normal position and the spacer in the maintenance position.

Advantageously, the spacer is formed such that in the maintenance position it is arranged substantially perpendicular to the cabin wall, on which the maintenance window is formed. Thus, the construction dimension of the spacer can be utilized for maximum efficiency. In variants, depending on the design of the spacer, it can be arranged at any angle. It is conceivable to provide a further panel arranged, for example, below the maintenance window that can be swung with its upper edge into the car space.

Particularly advantageous turned out to be an arrangement of the spacer, in which the spacer in the maintenance position protrudes through the maintenance window into the car interior. In this way, fastening or securing means may be located outside of the interior, where they are accessible only after the opening of the maintenance window from inside the car.

Advantageously, the spacer is movably supported on the elevator car. in this case it can be is in particular brought from the maintenance position into a rest position (and vice versa). For example, the spacer may be designed extendable, such as in the rest position, i.e. it can serve in normal operation of the elevator as a handrail, which can be drawn in case of maintenance in longitudinal guides inside the car in the maintenance position. It is also conceivable in principle, as mentioned, that the spacer is designed as a swing-in part into the interior car of the car wall, for example as another panel. However, the spacer can be mounted movable so that in the rest position and the maintenance position it is fixed rigidly inside the car and is movable only in the transition from one position to the other.

Preferably, the spacer between the rest position and the maintenance position is pivoted on the elevator car. In particular, the spacer is pivotable in a substantially direction parallel to the car floor and the car wall and the parallel direction. In this way, the spacer can be arranged in the rest position, for example, in a particularly space-saving position parallel to the car wall while it is swung in the maintenance position inside the car. Here, the spacer is advantageously arranged in the rest position such that it is can be covered by the panel when it is placed in the normal position. In variants, the spacer may be formed as a fold-out element of an inner-wall-paneling in the car wall, such as a folding bracket. Advantageously, the spacer extends at least over the entire width of the inside opening of the maintenance window. In the present case, width refers to a dimension in the direction parallel to the car wall and the car floor. In this manner it is ensured that from any position of the car interior the safe distance from the maintenance window provided by the spacer is maintained.

As mentioned above, the spacer may be formed in different ways. Especially preferably, however, the spacer comprises a bracket, which is in particular U-shaped. In this way, in a simple design provides a light spacer. The bracket can be supported at its free arms in pivot bearings inside the car. Preferably, however, the bracket is mounted in respective bearings and in a rest position is arranged with the bracket plane substantially parallel to the car wall. The bracket can be secured by bolts in a maintenance position to a support structure of the elevator car, in which it extends substantially perpendicular to the car wall into the car interior. For easy mounting, e.g. wing nuts can be used, wherein the free ends of the bracket can be angled to provide a good mounting surface.

As already mentioned, the spacer is formed and arranged in the maintenance position in such a manner that the safety distance to the car wall or to the passing elevator components at a predetermined level above the bottom of the elevator car is guaranteed. It is understood that the barrier can also extend at a constant distance up to the floor and not only at a predetermined level ensuring the safety distance.

The invention also relates to an elevator system, e.g. in a building, with an elevator car as described herein.

Further advantageous embodiments and combinations of features of the invention follow from the following detailed description.

### DESCRIPTION OF THE DRAWINGS

The figures used to explain the embodiments shown schematically:

FIG. 1 is a sectional view of an elevator car with a maintenance window with a spacer designed as a bracket;

FIG. 2 is a vertical plan view of a section of a car wall of an inventive elevator car with a maintenance window with a bracket in a maintenance position;

FIG. 3 shows a view of the arrangement in FIG. 2 with a view direction parallel to the car wall and from the top perpendicular to the car floor; and

FIG. 4 is a similar view as in FIG. 2, wherein the bracket is in a rest position.

### DETAILED DESCRIPTION

Generally corresponding parts are designated by like reference numerals in the figures.

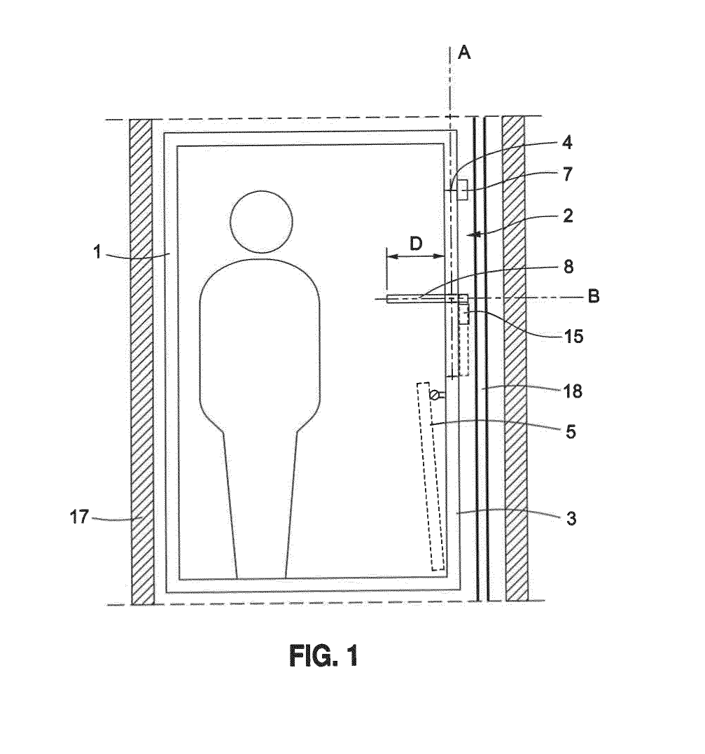

FIG. 1 shows a sectional view of an elevator car 1 with the maintenance window 2 with a bracket 8 formed as a spacer. In the present case “down” refers to a direction to a car floor of the elevator car.

The elevator car 1 is located in an elevator shaft 17, where between the elevator car 1 and a wall of the elevator shaft 17 different elevator components 18 are located. The elevator components 18 may include, depending on the type of elevator system, cables, rails, drives, counterweights, etc., and, in this case, are indicated just as two ropes. Preferably, the elevator components 18 are disposed on only one side of the elevator car 1. The elevator components 18 are therefore accessible through the maintenance window 2, which is formed at a corresponding car wall 3.

In the normal case, i.e. under normal person operation, an opening 4 of the maintenance window 3 is closed by a panel 5 (shown in dashed line). The opening 4 is arranged in a plane of the opening A, which coincides with a plane of the car wall 3. During maintenance, the maintenance window can be opened, far example, as it is completely removable. During maintenance, the panel 5 can be placed on a car floor or, as shown in FIG. 1, is mounted on a handrail to the car wall 3 (shown in dashed line).

A first protection contact 7 is disposed at an upper edge of the opening 4 such that a presence of the panel 5 in the hole 4 can be determined, that is, when the opening 4 is closed by the panel 5 in a normal position. Preferably, the protective contact 7 can be activated directly by the panel 5 when this closes the opening 4. With an activated protection contact 7 a normal travel is possible, for example, in a normal person operation. A controller (not shown) of the safety device, comprising the protection contact 7 can be integrated, for example, in a controller of the elevator car or elevator system or designed as a separate unit.

In a rest position (shown in dashed line) the spacer 8 designed as bracket is arranged outside the elevator car 1 in the region of the opening 4. The bracket 8 is, for example, during normal operation of the elevator system in the rest position. In this position a plane B of the bracket 8 is parallel to an outer side of the car wall 3, offset outwardly therefrom. The bracket 8 is thus placed on the outside of the elevator car in a space-saving placement.

With the maintenance window 2 open, the protective contact 7 is disabled, thus preventing a travel the elevator car 1, as long as the bracket 8 does not provide a safety barrier. An elevator mechanic can now manually move the bracket 8, for example, into a maintenance position, in which the bracket 8 ensures a barrier at a safe distance to the maintenance window 2 or to the elevator components 18. In the maintenance position, the bracket 8 plane is arranged substantially perpendicularly to the car wall 3 so that the bracket 8 extends as far as possible into the car interior. In the present case, the bracket 8 is outside the elevator car 1 pivotally attached to this essentially so that it can be pivoted inside the car into the maintenance position from the rest position through the opening 4. The bracket 8 is designed such that a safety barrier is provided at the distance D from the car wall 3.

Another protective contact 15 of the safety device monitors the position of the bracket 8. In particular, the protection contact 15 can be activated when the bracket 8 gets into the maintenance position. With the activation of the protective contact 15 an inspection travel is released, for example, via the aforementioned controller of the security apparatus.

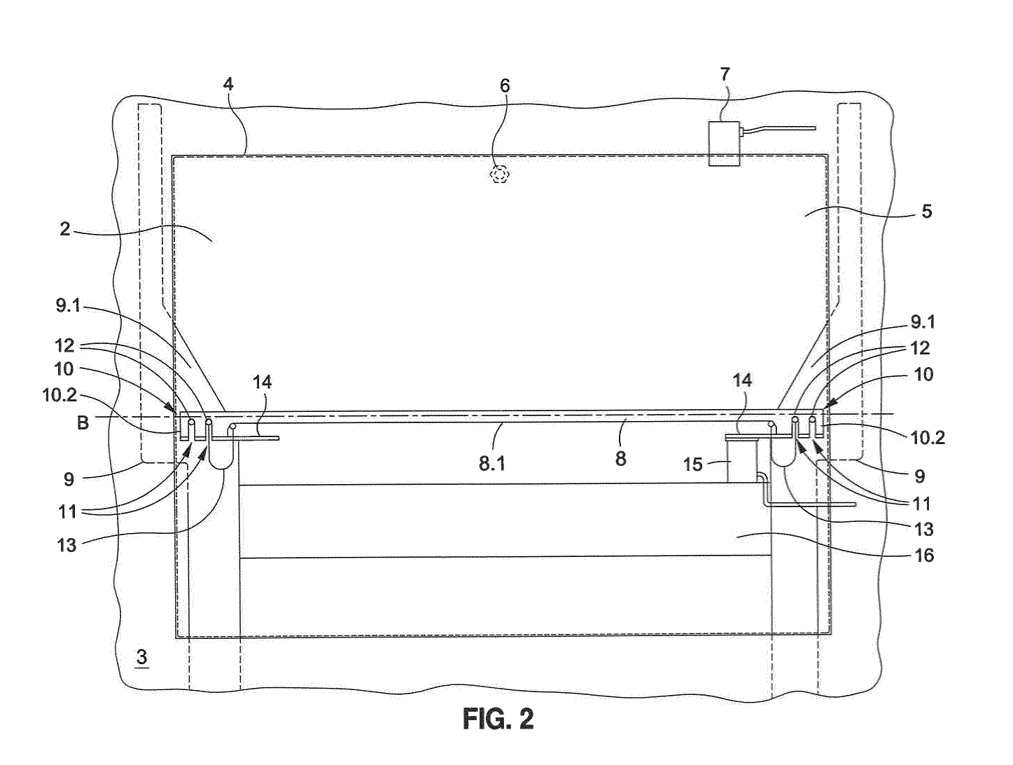

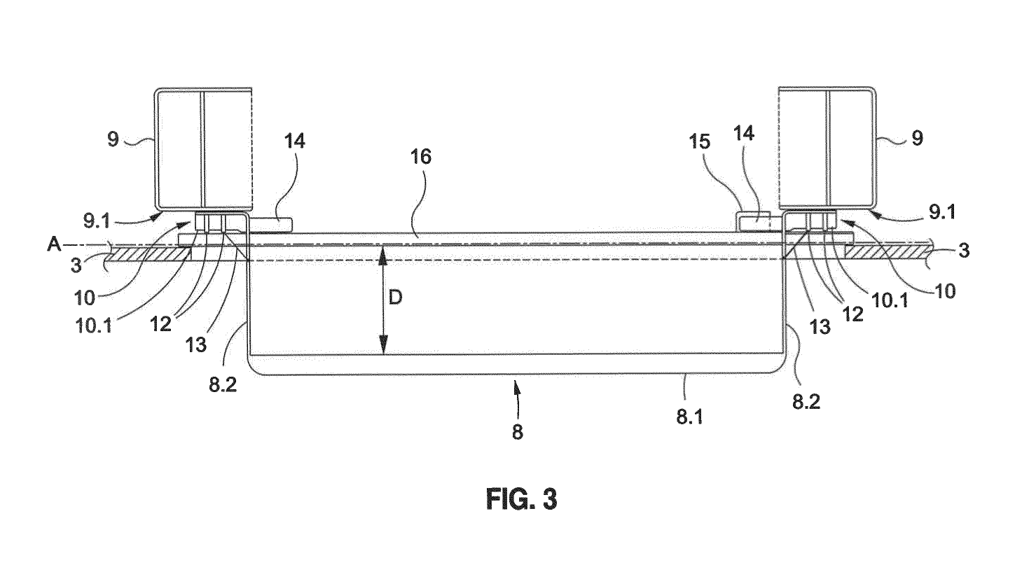

FIG. 2 shows a vertical plan view of a section of the car wall 3 of the inventive elevator car 1 with the maintenance window 2. The view direction is perpendicular to the car wall 3 of the car interior. FIG. 3 shows a view of the assembly of FIG. 2 with a view direction parallel to the car wall 3, from above perpendicular to the car floor. In the following text are described together FIGS. 2 and 3.

The clear opening 4 of the maintenance window 2 is formed in the plane of the car wall 3. The panel 5 has a corresponding contour of the opening 4 and can be used in this (indicated by dashed lines). On the panel 5, a lock 6 is arranged centrally in an upper region, with which the panel 5 can be locked in the opening 4 in a normal position. In the normal position panel 5 closes the opening 4. In a region at the upper right corner of the opening 4 is arranged the protection contact 7. Using the protection contact 7, one can determine whether the panel 5 is in the normal position.

The spacer 8 shaped as a U-shaped bracket 8 protrudes perpendicular to the car wall 3 inside the car and is mounted on supports 9 of the elevator car 1. The supports 9 are fixedly arranged in the area of the clear opening 4 to both sides outside the car wall 3. The supports 9 each comprise a side surface 9.1 that faces the opening 4, to which the bracket 8 is secured with one of its arms 8.2. The bracket 8 protrudes from the supports 9 arranged at the outer side through the opening 4 into the car interior. In the inside of the car the bracket 8 spans with a connection section 8.1 that connects the arms 8.2 the opening 4 substantially all over its width. The connecting portion is 8.1 spaced inwardly at a safety distance D from the car wall 3 or from the plane A of the opening 4.

On the arms 8.2 of the bracket 8 are provided laterally arranged mounting lugs 10 for attachment to the supports 9. The mounting lugs 10 are formed as profile strips with an L-shaped cross section. One of the side walls of each mounting lugs 10 (side walls 10.1) is arranged parallel to the bracket level B, while the other side wall (side walls 10.2) is oriented in each case perpendicularly to the plane B. In the maintenance position of FIG. 2 the side walls 10.1 are disposed below the bracket level B, while the side walls 10.2 are parallel to the lateral surfaces 9.1 of the supports 9 and thus also parallel to the car wall 3.

The mounting lugs 10 each comprise two slits 11 open to one side and perpendicular to the two side walls 10.1 and 10.2. The slots 11 extend through both side walls 10.1 and 10.2 of the respective mounting lug 10 and are open at the end at an edge of the side walls 10.1.

The bracket 8 is mounted with the slots 11 on two side surfaces 9.1 on the bolt 12. The bracket 8 is fastened with wing nuts (not shown) on the bolts 12. In the maintenance position of FIG. 2, the side walls 10.2 of the mounting lugs 10 are clamped by the wing nuts to the support 9. The side walls 10.1 run in the maintenance position below the bolt 12. The bracket 8 is also connected at two arms 8.2 to the bolts 12 by a tether 13 designed as a safety chain. In this way, should the bracket 8 when loosening the wing nuts slip off the bolt 12, it cannot fall into the elevator shaft.

The side walls 10.1 of the mounting lugs 10 extend in the opposite direction of the mounting lugs 10 on the respective arm of 8.2 of the bracket 8 in extensions 14. Below one of the extensions 14, in the view of FIG. 2 on the right side, is located a protection contact 15. On an upper side, the protection contact 15 has a contact surface for activation. The protection contact 15 is arranged on a cross beam 16 that spans the opening 4. In the maintenance position, the right-hand extension 14 contacts the contact surface of the protection contact 15 and activates it. By means of the protection contact 15 one can thus establish that the bracket 8 is in the maintenance position.

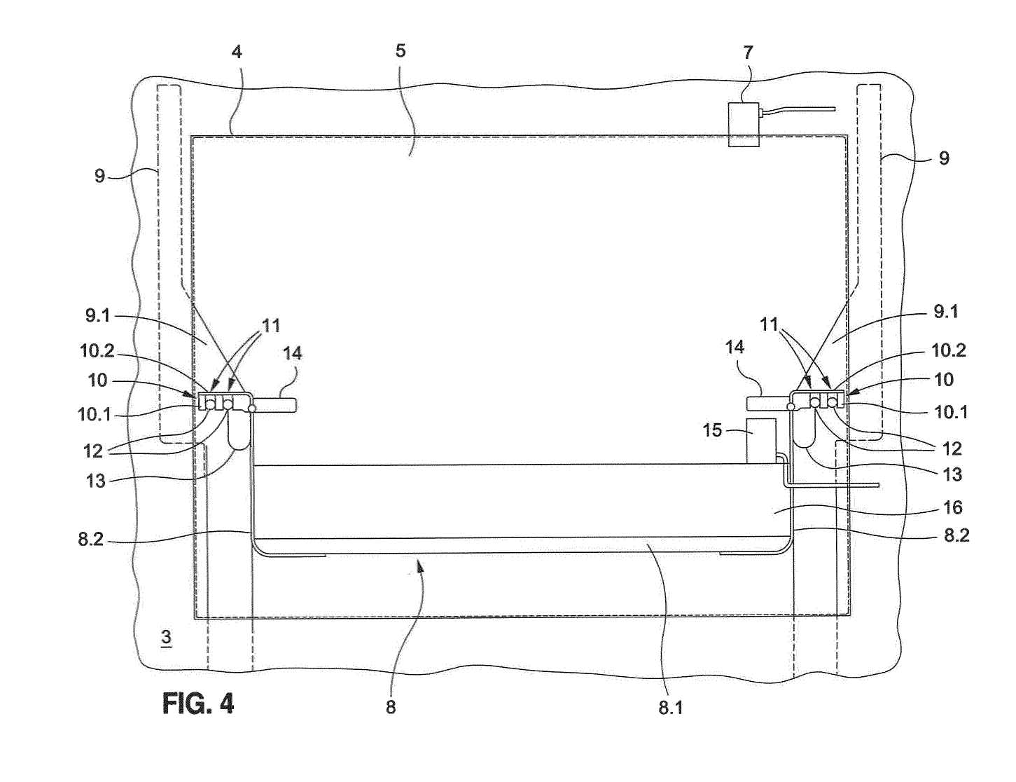

FIG. 4 shows a similar view as FIG. 2, with the spacer bracket 8 in a rest position. To transition from the maintenance position (FIG. 2) to the rest position (FIG. 4) the wing nuts on the bolts 12 can be loosened. Due to the slots 11, with loosened wing nuts the bracket 8 mounted on the bolts 12 can be swung downwards. The bolts 12 thereby slide in the slots 11 from the side walls 10.2 into the side walls 10.1. The side walls 10.2 are swiveled upwards and are arranged in the rest position above the bolts 12. The bolts 12 are in relation to a lower edge of the opening 4 farther apart than the distance D so that the bracket 8 can be pivoted downwardly and through the aperture 4 to the outside. The bracket plane B is arranged in the rest position parallel both to plane A outside of the car wall 3 and to side faces 9.1 of the supports 9.

By pivoting of the bracket 8 in the transition to the rest position, the extension 14 is elevatored off the protective contact 15 from the contact surface upwards and also swiveled. The protection contact 15 is thus deactivated, whereby a normal drive and an inspection travel the elevator car is locked as long as the panel 5 is not in the normal position.

By tightening the wing nuts, the side walls 10.1 of the mounting lugs 10 can be clamped to the supports 9. The bracket 8 is thus fixed in the rest position. The panel 5 can be inserted into the opening 4 (normal position), and the bracket 8 is covered. By the insertion of the panel 5 the protection contact 7 is activated, whereby a normal travel is enabled.

In accordance with the provisions of the patent statutes, the present invention has been described in what is considered to represent its preferred embodiment. However, it should be noted that the invention can be practiced otherwise than as specifically illustrated and described without departing from its spirit or scope.

1-14. (canceled)

15. An elevator car with a lateral maintenance window and a removable panel that in a normal position covers an opening in the maintenance window, comprising:
a spacer mounted on an exterior of the elevator car in a rest position at the maintenance window and is movable into a maintenance position in an interior of the elevator when the panel is removed from the maintenance window opening, the spacer in the maintenance position providing a barrier at a distance from elevator components outside the maintenance window opening; and
a safety device monitoring whether the panel is covering the maintenance window opening and whether the spacer is in the maintenance position, which safety device blocks a normal travel and an inspection travel of the elevator car if the panel is not in the normal position and the spacer is not in the maintenance position and by which the inspection travel is only released when the spacer is in the maintenance position.

16. The elevator car according to claim 15 wherein the inspection travel is automatically released by the safety device once the spacer is in the maintenance position.

17. The elevator car according to claim 15 wherein the safety device includes a first protection contact activated by moving the panel into the normal position.

18. The elevator car according to claim 17 wherein the safety device includes a second safety contact activated by moving the spacer into the maintenance position.

19. The elevator car according to claim 15 wherein the spacer in the maintenance position is arranged substantially perpendicular to a car wall at which the maintenance window is formed.

20. The elevator car according to claim 15 wherein the spacer in the maintenance position is projecting through the maintenance window opening into the car interior.

21. The elevator car according to claim 15 wherein the spacer is mounted movably on the elevator car for movement between the maintenance position and the rest position.

22. The elevator car according to claim 15 wherein the spacer is mounted on the elevator car for pivotal movement between the rest position and the maintenance position.

23. The elevator car according to claim 15 wherein the spacer is arranged in the rest position such that the spacer is covered by the panel relative to the elevator car interior when the panel is brought into the normal position.

24. The elevator car according to claim 15 wherein the spacer extends substantially over an entire width of the maintenance window opening.

25. The elevator car according to claim 15 wherein the spacer is formed as a U-shaped bracket.

26. The elevator car according to claim 15 wherein the spacer is configured and disposed in the maintenance position at the distance to provide a barrier at a predetermined height above a floor of the elevator car.

27. The elevator car according to claim 15 wherein the panel in the normal position is locked by a locking device.

28. An elevator installation with an elevator car according to claim 15.
